(19) United States
(12) Patent Application Publication
(10) Pub. No.: US 2008/0247573 A1
(43) Pub. Date: Oct. 9, 2008

(54) Miniature capacitive acoustic sensor with stress-relieved actively clamped diaphragm

(75) Inventor: Michael Pedersen, Ashton, MD (US)

Correspondence Address: NOVUSONIC CORPORATION, P.O. BOX 183, ASHTON, MD, 20861, US

(73) Assignee: NOVUSONIC CORPORATION

(21) Appl. No.: 12/080,062

(22) Filed: Mar. 31, 2008

Related U.S. Application Data
(60) Provisional application No. 60/910,468, filed on Apr. 6, 2007.

(51) Int. Cl. H04R 25/00

(52) U.S. Cl. 381/174

(57) ABSTRACT

An acoustic sensor is disclosed which can be fabricated on a single chip with an electronic detection circuit by modular integration of the fabrication processes. An advantage of the disclosed acoustic sensor with on-chip signal detection circuit is smaller overall device size and lower sensitivity to electromagnetic interference and vibration. A second advantage of the disclosed acoustic sensor is the combined stress-relief and electrostatic clamping design of the diaphragm, which allows for further reduction of the diaphragm size, and hence device size, without compromising the microphone acoustic sensitivity, and at same time eliminates issues with diaphragm bow normally associated with stress-relief techniques.

This application claims priority of U.S. provisional patent application No. 60/910,468 hereby incorporated by reference.

### FIELD OF THE INVENTION

The invention relates to the fields of acoustic transducers and sensors. Specifically, it relates to the field of capacitive microphones made using micro machining (MEMS) fabrication processes.

### BACKGROUND OF THE INVENTION

A number of important prior art inventions have been disclosed in which various design and fabrication methods are employed to achieve a stress reduction of the microphone diaphragm. A common issue in the fabrication of thin-film diaphragms using micro machining technology is the control and repeatability of the intrinsic stress in the thin film materials. As the intrinsic stress of the diaphragm strongly affects the acoustic compliance of the diaphragm, and hence the sensitivity of the microphone, there is therefore a direct relationship between the repeatability of the diaphragm intrinsic stress and the microphone sensitivity. In general, it is quite difficult to repeatedly fabricate thin-films with low intrinsic stress, and therefore a higher intrinsic stress is chosen, which may be better controlled on a relative scale. The problem with this approach, however, is that due to the high intrinsic diaphragm stress, the acoustic compliance of the diaphragm is relatively small. To achieve a certain required microphone sensitivity, the lacking diaphragm compliance must be compensated for by making the diaphragm very thin and/or relatively large, which results in a larger overall device size and difficulty in manufacture.

A common approach to eliminate or reduce the significance of the diaphragm intrinsic stress is to design a mechanical structure in which the diaphragm intrinsic stress is effectively eliminated or drastically reduced. The primary benefit from such designs is to allow for smaller diaphragms and devices, while at the same reducing the requirement stress control in the fabrication process. A number of such mechanical structures have been disclosed in the prior art.

The prior-art integrated acoustic sensor (FIG. 1) was disclosed by Loeppert and Schafer in U.S. Pat. No. 5,870,482. In this device a sensitive diaphragm is anchored in the center of the structure, and the diaphragm deflection is detected along its perimeter. Due to the single central attachment point of the diaphragm, the intrinsic stress in the diaphragm is effectively relieved. The acoustic sensor structure was integrated with a MOS process for the fabrication of electronic circuits on the same substrate. A drawback of this prior-art structure is that while the issue of repeatability of intrinsic stress is eliminated, a new issue is introduced which relates to the flatness of the free diaphragm. It is found that the in order to control the acoustic leakage resistance at the perimeter of the diaphragm, which determines the lower roll-off frequency in the device, and the sensitivity of the transducer, the flatness of the centrally suspended diaphragm must be tightly controlled. The flatness is determined by the stress eccentricity of the diaphragm material, which is difficult to control during fabrication, and therefore causes a variation from device to device. This problem is accentuated if the diaphragm consists of different materials, since mismatch of material thermal expansion properties and initial intrinsic stress will then contribute to the diaphragm stress eccentricity (also named gradient).

A second prior-art acoustic sensor (FIG. 2) was disclosed by Loeppert and Pedersen in U.S. Pat. No. 6,535,460. In this device, a free-floating diaphragm is realized on a silicon substrate. The diaphragm is completely free within its plane, and only confined by the underlying substrate and a number of point-or line-shaped stand-offs incorporated in the back plate. The height of the standoffs determines the air gap in the microphone during operation. The intrinsic stress in the diaphragm is effectively eliminated, since the diaphragm is free to expand or contract in its plane. A drawback of this structure is that while the intrinsic diaphragm stress is eliminated, the stress eccentricity is not. Therefore, a bow of the diaphragm will occur if there is any stress gradient in the diaphragm material. Diaphragm bow affects the effective air gap in the microphone, and therefore the microphone sensitivity, and in some cases the frequency response. A second drawback of this structure is that it is fabricated using materials that are not compatible with the fabrication of integrated circuits. This structure cannot be integrated with a signal processing circuit on a single substrate.

A third prior-art acoustic sensor (FIG. 3) is disclosed by Pedersen in U.S. Pat. No. 7,146,016. In this device, a free diaphragm is formed on a silicon substrate into which a back plate has been pre-formed. The diaphragm is attached to the substrate only by a small number of flexible springs. The intrinsic stress of the diaphragm is practically eliminated, thereby allowing a reduction of the diaphragm size. The air gap between the diaphragm and back plate is controlled by the height of a lip integrated into the perimeter of the diaphragm. While this structure is different from the prior-art structures in FIG. 1 and FIG. 2, it suffers from the same drawback that while the intrinsic stress is practically eliminated, any stress gradient will cause bow of the diaphragm and therefore a variation in microphone sensitivity.

A fourth prior-art acoustic sensor (FIG. 4) is disclosed by Loeppert and Lee in U.S. Pat. No. 7,023,066. In this device, the diaphragm is attached to a number of support posts through a similar number of suspension beams. This structure allows for the reduction of the diaphragm intrinsic stress by in-plane rotation of the diaphragm. While this design is effective in the elimination of intrinsic stress, it suffers the same sensitivity to stress gradients within the diaphragm material as the abovementioned prior-art designs. A stress gradient will cause a bow of the diaphragm.

A fifth prior-art acoustic sensor (FIG. 5) is disclosed by Aigner et al in PCT patent application WO 03/068668. In this device, the intrinsic stress is reduced and the diaphragm bow due to material stress gradients is reduced by the use of curved radial suspension beams. While such a diaphragm suspension design, according to the inventors, can reduce significantly the diaphragm bow due to stress gradients, the problem is that the diaphragm also remains relatively stiff due to the radial beam suspension. As a result, the intrinsic stress in the diaphragm is not reduced to the same low level as in the other prior-art structures enumerated above. A further problem with this prior art structure is the control of the acoustic bypass of the diaphragm around the suspension beams. This affects the low frequency behavior of the microphone response,

A sixth prior-art acoustic sensor is disclosed by Füldner et al. in the research paper titled Analytical Analysis and Finite Element Simulation of Advanced Membranes for Silicon Microphones in IEEE Sensors Journal, vol. 5(5), October 2005, pp. 857-863. In this device, the intrinsic stress in the diaphragm is relieved by the formation of corrugations along the perimeter of the diaphragm. While this method is effective in the reduction of the diaphragm intrinsic stress, the out-of-plane bending at the corrugations results in a significant bow of the diaphragm, which affects the microphone performance and device repeatability in similar fashion as the prior-art structures mentioned above.

### SUMMARY OF THE INVENTION

While significant prior-art exists in the area of the design of acoustic sensors with stress-relieved or low-stress diaphragms, fundamental issues with diaphragm material properties and the control thereof remain.

It is therefore an object of this invention to devise an acoustic sensor structure, in which the influence of the diaphragm intrinsic stress and stress eccentricity can be drastically reduced without the associated variation in microphone performance.

It is a further object of this invention to realize such an acoustic sensor structure, in which the diaphragm has a relieved intrinsic stress, while remaining flat without bow.

It is a further object of this invention to realize such an acoustic sensor structure, in which the low frequency behavior of the sensor is tightly controlled by limiting the acoustic bypass around the diaphragm in the device.

It is a further object of this invention to realize such an acoustic sensor structure utilizing a fabrication process that would allow for the structure to be integrated on the same substrate as the necessary electronic signal-conditioning circuitry.

It is a further object of this invention to realize such an acoustic sensor structure with minimal fabrication complexity to minimize fabrication cost and to maximize the fabrication yield.

It is yet a further object of this invention to realize such an acoustic sensor structure with performance properties that would allow for operation in battery powered low-voltage systems.

### BRIEF DESCRIPTION OF THE ATTACHED DRAWINGS

FIG. 1 is a three dimensional cut-away view of a prior-art integrated acoustic sensor according to U.S. Pat. No. 5,870,482.

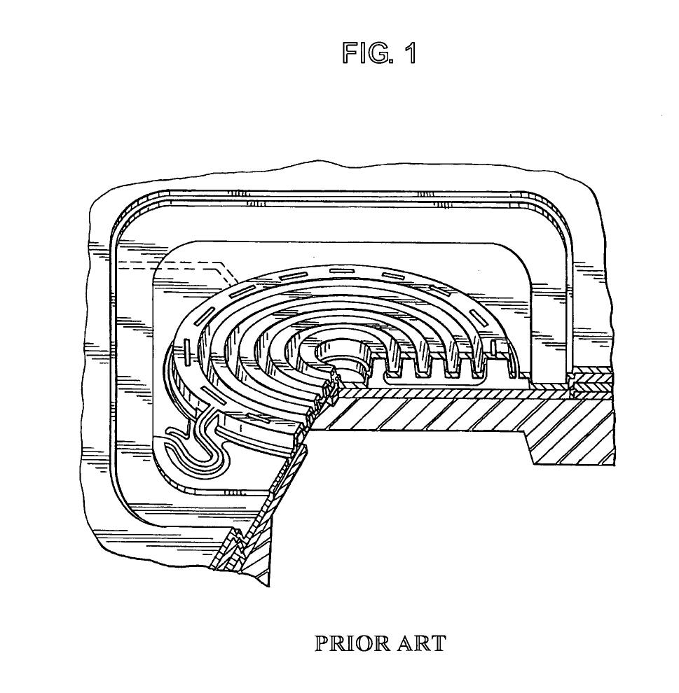

FIG. 2 is a three dimensional cut-away view of a prior-art acoustic sensor according to U.S. Pat. No. 6,535,460.

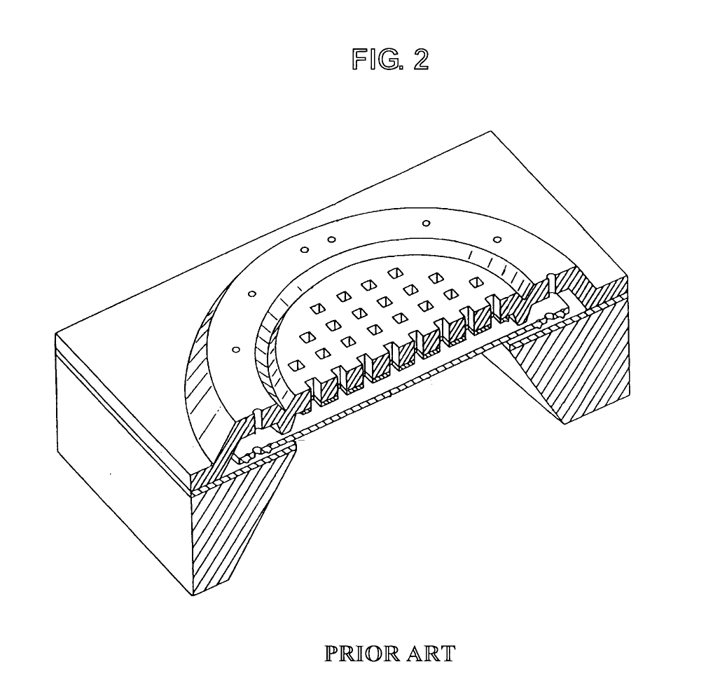

FIG. 3 is a three dimensional cut-away view of a prior-art acoustic sensor according to U.S. Pat. No. 7,146,016.

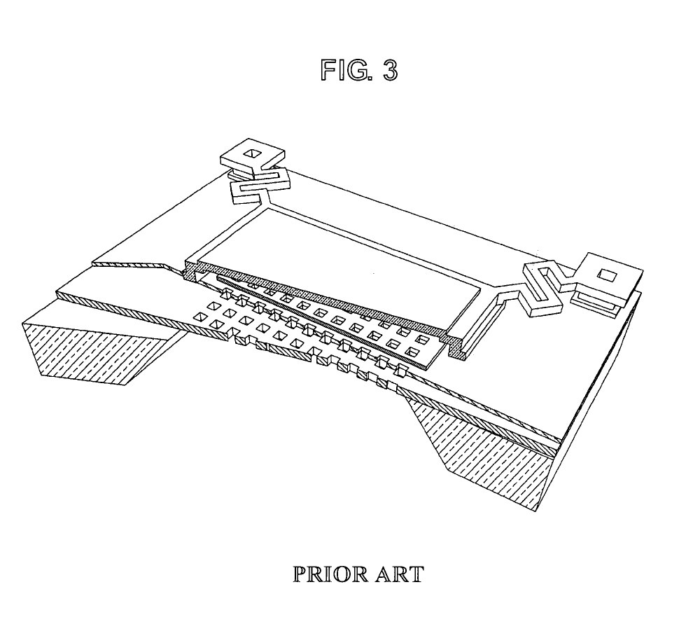

FIG. 4 is a three dimensional cut-away view of a prior-art acoustic sensor according to U.S. Pat. No. 7,023,066.

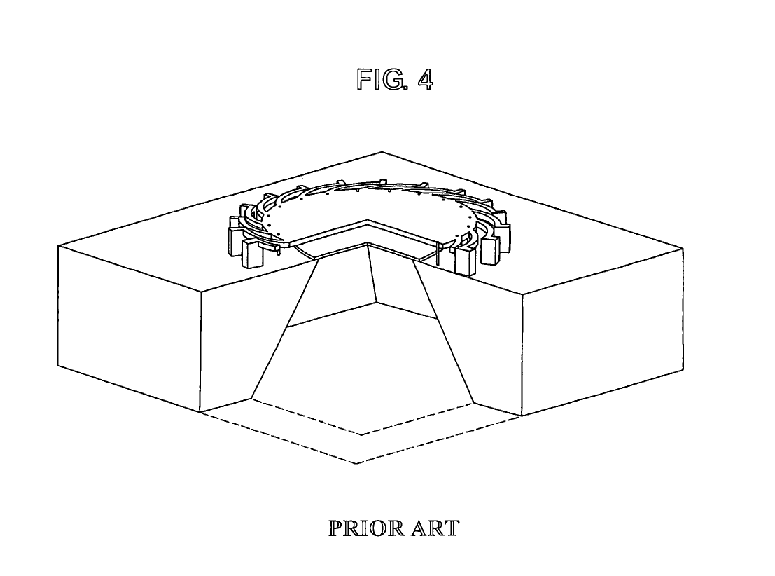

FIG. 5 is a top view of a prior-art acoustic sensor according to PCT patent application WO 03/068668.

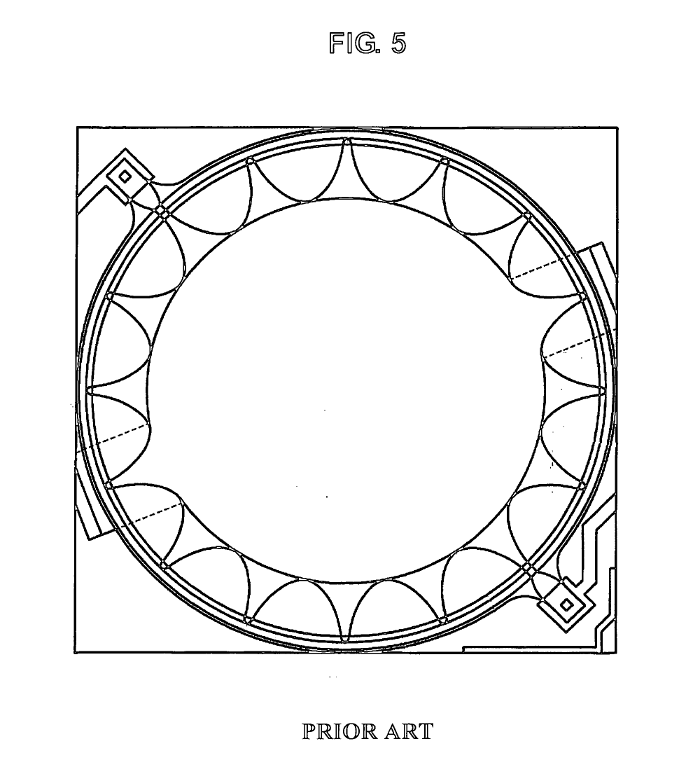

FIG. 6 is a top view of an acoustic sensor according to the present invention.

FIG. 7 is a cross-sectional view of an acoustic sensor according to the present invention taken along the section line A-A in FIG. 6.

FIG. 8 is a three dimensional cut-away view of an acoustic sensor according to the present invention.

FIG. 9 is a cross-sectional view of an acoustic sensor according to the present invention showing the net electrostatic forces on the diaphragm as result of an applied DC bias voltage.

FIG. 10 is a cross-sectional view of an acoustic sensor according to the present invention in which the diaphragm has collapsed onto the substrate as result of an applied DC bias voltage.

### DETAILED DESCRIPTION OF THE INVENTION

The present invention arises from the realization that the electrostatic attraction force, which is always present in a capacitive acoustic sensor structure, can be utilized in a specially designed structure to provide a clamping force of the diaphragm, which in turn can serve to flatten a diaphragm with intrinsic bow and provide for an effective acoustic seal between the diaphragm and the opposing clamping surface. A further important realization that applies to the present invention is that such a structure can be implemented using materials and fabrication processes that are entirely compatible with electronic circuit fabrication processes, such as CMOS, thereby allowing the fabrication of the acoustic sensor structure directly on substrates containing electronic circuitry.

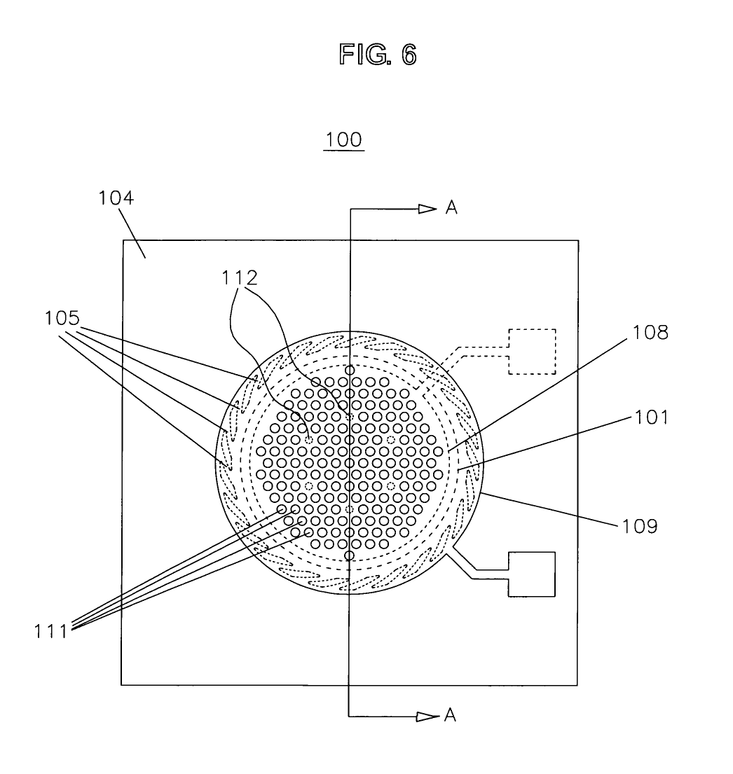

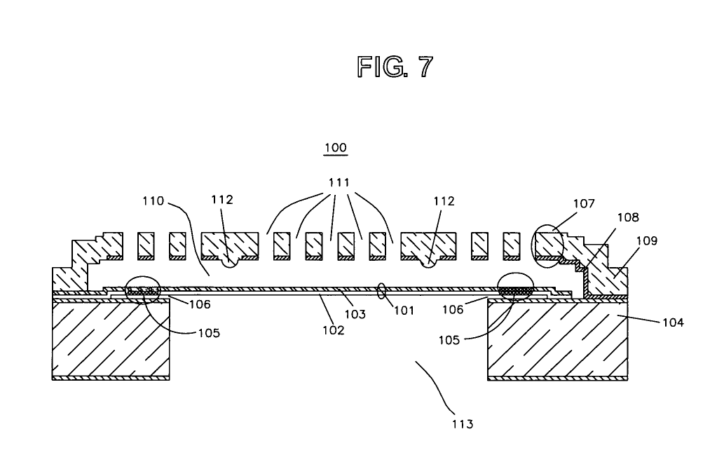

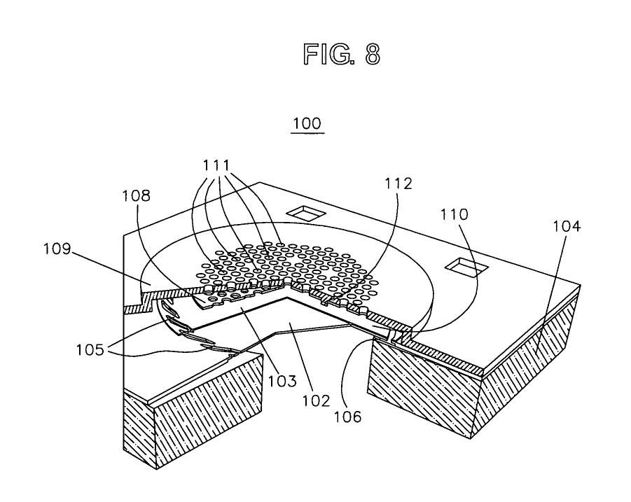

A preferred embodiment of the acoustic sensor 100 according to the present invention is shown in top view in FIG. 6, cross-sectional view in FIG. 7, and three-dimensional cut-away view in FIG. 8. The sensor structure consists of a diaphragm 101 formed from dielectric layer 102 and conductive layer 103. The diaphragm is attached to the conducting or semi conducting substrate 104 through a number supporting beams 105. The supporting beams 105 are shaped as to allow significant relief of the intrinsic stress in the diaphragm 101, by allowing the diaphragm to rotate within its plane. A small air gap 106 is formed between the diaphragm and substrate in an overlapping area near the perimeter of the diaphragm. Above the diaphragm, a back plate 107 is formed from conductive layer 108 and dielectric layer 109. The back plate is separated from the diaphragm by an air gap 110, which is significantly larger than air gap 106. The back plate contains a number of holes 111 that enable fabrication of the structure, and serve as venting holes for the air in the gap 110, thereby allowing the air to escape with minimal damping. The back plate also contains a number of standoffs 112 that prevent direct electrical contact between conductive layers 103 and 108, in case the diaphragm comes into mechanical contact with the back plate.

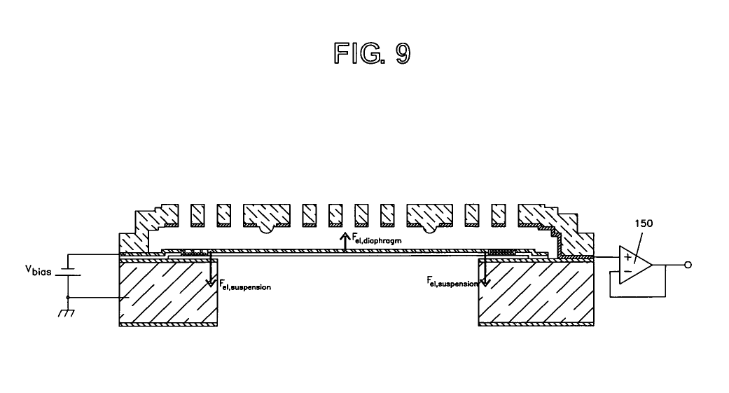

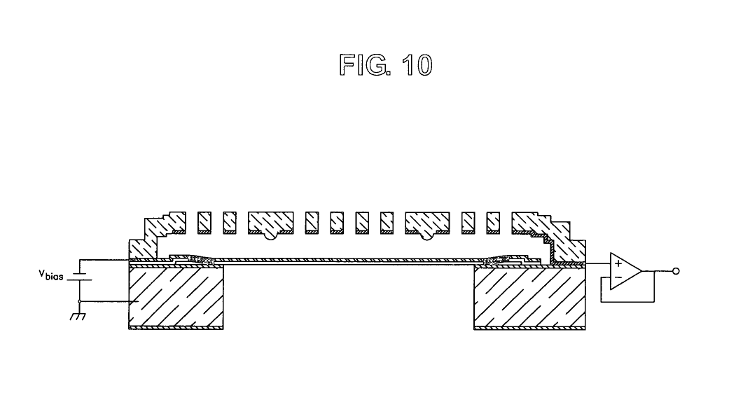

In operation (FIG. 9), a DC bias voltage is applied to conductive layer 103, the substrate 104 is connected to electrical ground, and conductive layer 108 is connected to a transconductance amplifier 150 with input bias level of 0V. As a result of the DC bias voltage, electrostatic attraction forces are exerted between the diaphragm and back plate, and the diaphragm and the substrate as shown in FIG. 9. The electrostatic attraction force is inversely proportional to the square of the conductor separation distance. As a result, in the areas where the diaphragm overlaps the substrate, the diaphragm will experience a net attraction force towards the substrate, since the air gap 106 is much smaller than air gap 110. In the center of the diaphragm, where the substrate is removed, the diaphragm experiences a net attraction force towards the back plate. If the stiffness of supporting beams 105 and the sizes of air gaps 106 and 110 are chosen properly, the diaphragm can be made to collapse on to the substrate at a given minimum DC bias voltage. For bias voltages above this minimum value, the diaphragm will be collapsed on the substrate as illustrated in FIG. 10. When the diaphragm collapses on the substrate, the electrostatic attraction force will increase significantly, since in this condition only dielectric layer 102 remains between conductive layer 103 and the substrate. As a result any intrinsic out-of-plane bow of the diaphragm will be eliminated, since the diaphragm is forced flat against the substrate. At the same time, when the diaphragm collapses on the substrate an effective acoustic seal is achieved between air gap 110 and back side cavity 113. This ensures highly reproducible low frequency behavior of the microphone. The flexural rigidity of supporting beams 105 is important to ensure the proper function of the device, and it should be carefully selected. The rigidity should be high enough to ensure sufficient device yield considering the imposed strains on the device during the fabrication process. Conversely, the rigidity should be low enough to effectively relieve the intrinsic stress in the diaphragm and allow for the electrostatic attraction force to collapse the diaphragm onto the substrate. Similarly, the air gaps 106 and 110 must be chosen such that the diaphragm to substrate collapse can occur at a DC bias voltage lower than the desired DC bias operating voltage.

While a specific embodiment has been illustrated and described, many variations and modifications in structure and materials may be apparent to those skilled in the art. Such variations shall also be claimed assuming they fall within the scope of the present invention.

What is claimed is:

1. An acoustic transducer structure comprising
an electrically conducting or semi-conducting supporting substrate containing at least one opening;
a diaphragm consisting of at least two material layers, of which at least one material layer is electrically conducting and at least one material layer is electrically insulating, disposed over said supporting substrate such that it covers said opening(s) and forms a continuous overlap area with the supporting substrate;
wherein said diaphragm is not in mechanical contact with said supporting substrate in said overlap area at rest;
means for attaching said diaphragm to said supporting substrate in a manner that allows for the reduction of the intrinsic stress in the diaphragm;
means for reducing the friction and adhesion forces between said diaphragm and support substrate when the two are in mechanical contact;
a perforated member disposed above said diaphragm, having at least one opening, being continuously attached to said supporting substrate along its entire perimeter, having at least one protrusion facing, but not touching, the diaphragm;
means for providing electrical conductivity of said perforated member in an area over said diaphragm;
means for providing a precise distance between said diaphragm and perforated member;
means for applying an external DC voltage between said conductive layer(s) on the diaphragm and the perforated member, and between said conductive layer(s) on the diaphragm and the supporting substrate;
wherein said DC voltage causes electrostatic attraction forces between said diaphragm and perforated member and said diaphragm and supporting substrate, such that the net force on the diaphragm causes it to move towards the supporting substrate until it makes mechanical contact in said overlap area, causing the diaphragm to become forced flat against the supporting substrate, thereby removing any intrinsic bow in the diaphragm;

2. The acoustic transducer according to claim 1, wherein said means for attaching the diaphragm to the supporting substrate are annular springs attached to the perimeter of the diaphragm.

3. The acoustic transducer according to claim 1, wherein said means for reducing the friction and adhesion forces between the diaphragm and supporting substrate involves the deposition of an anti-stiction coating layer on the diaphragm and the supporting substrate.

4. The acoustic transducer according to claim 1, wherein said means for reducing the friction and adhesion forces between the diaphragm and supporting substrate involves the formation of at least one protrusion in the diaphragm facing the supporting substrate.

5. The acoustic transducer according to claim 1, wherein said means for providing electrical conductivity of the perforated member involves the formation of an electrically conductive layer on the perforated member.

6. The acoustic transducer according to claim 1, wherein said means for providing electrical conductivity of the perforated member is achieved by forming the perforated member from an electrically conductive material.

7. The acoustic transducer according to claim 1, wherein said means for providing a precise distance between the diaphragm and the perforated member involves the deposition and subsequent removal of a temporary sacrificial layer.

8. The acoustic transducer according to claim 1, wherein said means for applying an external DC voltage involves the formation of electrical interconnection structures on the supporting substrate or the perforated member.

9. The acoustic transducer according to claim 1, in which an effective acoustic seal is formed when the diaphragm is in mechanical contact with the supporting substrate.

10. An acoustic transducer structure comprising
an electrically conducting or semi-conducting supporting substrate containing at least one opening;
a diaphragm disposed over said supporting substrate such that it covers said opening(s) and forms a continuous overlap area with the supporting substrate;
wherein said diaphragm is not in mechanical contact with said supporting substrate in said overlap area at rest;
means for attaching said diaphragm to said supporting substrate in a manner that allows for the reduction of the intrinsic stress in the diaphragm;
means for providing electrical conductivity of said diaphragm;
means for reducing the friction and adhesion forces between said diaphragm and support substrate when the two are in mechanical contact;
a perforated member disposed above said diaphragm, having at least one opening, being continuously attached to said supporting substrate along its entire perimeter;
means for providing electrical conductivity of said perforated member in an area over said diaphragm;
means for providing a precise distance between said diaphragm and perforated member;
means for applying an external DC voltage between said diaphragm and the perforated member, and between said diaphragm and the supporting substrate;
wherein said DC voltage causes electrostatic attraction forces between said diaphragm and perforated member and said diaphragm and supporting substrate, such that the net force on the diaphragm causes it to move towards the supporting substrate until it makes mechanical contact in said overlap area, causing the diaphragm to become forced flat against the supporting substrate, thereby removing any intrinsic bow in the diaphragm;

11. The acoustic transducer according to claim 10, wherein said means for attaching the diaphragm to the supporting substrate are annular springs attached to the perimeter of the diaphragm.

12. The acoustic transducer according to claim 10, wherein said means for reducing the friction and adhesion forces between the diaphragm and supporting substrate involves the deposition of an anti-stiction coating layer on the diaphragm and the supporting substrate.

13. The acoustic transducer according to claim 10, wherein said means for reducing the friction and adhesion forces between the diaphragm and supporting substrate involves the formation of at least one protrusion in the diaphragm facing the supporting substrate.

14. The acoustic transducer according to claim 10, wherein said means for providing electrical conductivity of the perforated member involves the formation of an electrically conductive layer on the perforated member.

15. The acoustic transducer according to claim 10, wherein said means for providing electrical conductivity of the perforated member is achieved by forming the perforated member from an electrically conductive material.

16. The acoustic transducer according to claim 10, wherein said means for providing a precise distance between the diaphragm and the perforated member involves the deposition and subsequent removal of a temporary sacrificial layer.

17. The acoustic transducer according to claim 10, wherein said means for applying an external DC voltage involves the formation of electrical interconnection structures on the supporting substrate or the perforated member.

18. The acoustic transducer according to claim 10, wherein said means for providing electrical conductivity of the diaphragm involves the formation of an electrically conductive layer on the diaphragm.

19. The acoustic transducer according to claim 10, wherein said means for providing electrical conductivity of the diaphragm is achieved by forming the diaphragm from an electrically conductive material.

20. The acoustic transducer according to claim 10, in which at least one protrusion is formed in the perforated member facing the diaphragm, the protrusion(s) being short enough to not touch the diaphragm.

21. The acoustic transducer according to claim 10, in which an effective acoustic seal is formed when the diaphragm is in mechanical contact with the supporting substrate.
